(19) United States
(12) Patent Application Publication
(10) Pub. No.: US 2026/0293799 A1
(43) Pub. Date: Oct. 1, 2026

(54) AUTONOMOUS ENERGY FIELD

(71) Applicant: DS2.0, LLC, Portland, TN (US)

(72) Inventor: Dean SOLON, Gallatin, TN (US)

(21) Appl. No.: 19/481,119

(22) PCT Filed: May 3, 2024
(86) PCT No.: PCT/US2024/027710

§ 371 Date: Nov. 3, 2025

Related U.S. Application Data
(60) Provisional application No. 63/463,713, filed on May 3, 2023.

(51) Int. Cl. A01D 34/00; A01D 101/00; B64U 20/80; B64U 101/40; G01S 17/89; G01S 17/931; G06V 10/774; G06V 20/10; G06V 20/17

(52) U.S. Cl. CPC A01D 34/008; B64U 20/80; G01S 17/89; G01S 17/931; G06V 10/774; G06V 20/17; G06V 20/188; A01D 2101/00; B64U 2101/40

(57) ABSTRACT

Methods, systems, and apparatus, including computer programs encoded on a computer storage medium, for implementing an autonomous energy field. In one aspect, a method includes deploying at least one drone that includes a remote sensing device; collecting, by the remote sensing device of the at least one drone, a scan of a geographic area; determining, based on the scan of the geographic area, a modification to the geographic area required to achieve a target state of the geographic area; determining, based on the collected scan, a given device that will be deployed to make the modification required to achieve the target state of the geographic area; and deploying the given device in the geographic area with instructions to make the modification required to achieve the desired state of the geographic area, wherein deploying the device comprises causing the given device to navigate within the geographic area.

### BACKGROUND

This specification relates to data processing and evaluating and controlling solar field operations. A solar field is a large area covered with solar panels that are used to generate electricity from the sun's energy. The panels are arranged in a grid-like pattern and connected to an inverter, which converts the DC electricity generated by the panels into AC electricity that can be used by homes and businesses. The location, layout, and operation of the solar field takes into account a number of factors, but generally, the goal is to maximize the amount of sunlight captured by the solar panels and ultimately converted to AC electricity.

### SUMMARY

In general, one innovative aspect of the subject matter described in this specification can be embodied in methods that include the actions of deploying at least one drone that includes a remote sensing device; collecting, by the remote sensing device of the at least one drone, a scan of a geographic area; determining, based on the scan of the geographic area, a modification to the geographic area required to achieve a target state of the geographic area; determining, based on the collected scan, a given device that will be deployed to make the modification required to achieve the target state of the geographic area; and deploying the given device in the geographic area with instructions to make the modification required to achieve the desired state of the geographic area, wherein deploying the device comprises causing the given device to navigate within the geographic area. Other embodiments of this aspect include corresponding systems, apparatus, and computer programs, configured to perform the actions of the methods, encoded on computer storage devices.

These and other embodiments can each optionally include one or more of the following features. The remote sensing device can be a Light Detection and Ranging (LIDAR) device. Collecting a scan of the geographic area can include generating a LIDAR mapping of a candidate solar field or wind power field.

Determining a modification to the geographic area required to achieve a target state of the geographic area can include determining that vegetation in the geographic area is required to be cut to achieve a height of the vegetation that is below a specified height. Deploying the given device in the geographic area can include causing a self-driving device to perform operations including navigating within the geographic area; and cutting the vegetation to a height that is less than the specified height.

Methods can include training a machine learning model to predict vegetation growth using a set of historical data, including at least one of vegetation growth history for the geographic area, vegetation management activity, or weather data; and generating a proposed vegetation management plan based on a predicted vegetation growth output by the machine learning model, wherein the proposed vegetation management plan specifies different vegetation cutting schedules for different subsections of the geographic area based on differences in predicted vegetation growth in the different subsections. Deploying the given device in the geographic region can include deploying the given device to the different subsections of the geographic area according to the proposed vegetation management plan.

Methods can include obtaining, from data collected using one or more sensors, a terrain report specifying one or more obstacles that will interfere with the navigation of the self-driving device within the geographic area; generating, based on the terrain report, a navigation path that reduces the interference of the one or more obstacles with the navigation of the self-driving device within the geographic area; and causing the self-driving device to navigate within the geographic area according to the navigation path.

Methods can include retrieving the navigation path from a storage location after causing the self-driving device to navigate the geographic area; determining, based on an updated terrain report, that a different obstacle will currently interfere with the navigation of the self-driving device within the geographic area; generating, based on the updated terrain report, an updated navigation path that differs from the navigation path; and causing the self-driving device to navigate the geographic area according to the updated navigation path.

Methods can include analyzing the collected scan; selecting, based on the analysis of the collected scan, installation locations for one or more of solar field components; generating instructions that, upon execution, cause the one or more autonomous vehicles to transport the one or more solar field components to the selected installation locations for the one or more solar field components; and causing the one or more autonomous vehicles to transport the one or more solar field components to the selection installation locations for the one or more solar field components.

Selecting installation locations for one or more solar field components can include selecting one or more of (i) installation locations for posts configured to support solar panels, (ii) inverters, (iii) transformers, (iv) service roads, or (v) a control station.

Methods can include detecting, by the self-driving device while navigating within the geographic area, an actionable condition; reporting, by the self-driving device, the actionable condition to a system controller configured to interact with the self-driving device and one or more other devices; causing, by the system controller, the one or more other devices to perform operations that resolve the actionable condition.

Detecting the actionable condition can include determining that vegetation is detected on a post of a solar panel; causing the one or more other devices to perform operations that resolve the actionable condition comprises causing a vegetation mitigation device to navigate to the location of the post of the solar panel and remove or spray the vegetation.

Detecting the actionable condition can include detecting a characteristic of an object that is not accurately represented in a database storing characteristics of objects located in the geographic area; and causing the one or more other devices to perform operations that resolve the actional condition comprises updating the database storing characteristics of the objects located in the geographic area to reflect the detected characteristic of the object.

Detecting the actionable condition can include detecting one or more of (i) an out of tolerance temperature reading on a solar panel, (ii) burn marks, (iii) electrical arcing, (iv) a crack in a solar panel, or (v) a ground fault that has not caused a solar panel failure condition; and causing the one or more other devices to perform operations that resolve the actional condition comprises causing the one or more other devices to perform one or more of (i) generating a visible or audible alarm, (ii) navigate a vehicle to a location of the actionable condition, or (iii) disabling the solar panel.

Methods can include monitoring a location of the given device within the geographic area; remotely adjusting, using one or more optical or electrical control signals, orientations of one or more objects within the geographic area to prevent navigation of the given device from being impeded as the given device approaches locations of the one or more objects.

Adjusting orientations of one or more objects can include adjusting a tilt angle of a solar panel to an angle that enables the given device to navigate under the solar panel.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an illustration of an example solar field.

FIG. 2 is an illustration of an aerial view of a solar field.

FIG. 3A-3F are illustrations of an autonomous mower approaching a set of solar panels.

FIG. 4 is a diagram of an environment in which machine learning models can be implemented.

FIG. 5 is a flow chart of an example process of autonomously modifying a geographic area.

Like reference numbers and designations in the various drawings indicate like elements.

### DETAILED DESCRIPTION

The present specification describes methods, systems, and computer readable medium that implement an autonomous green energy facility (e.g., solar or wind power plant), which is referred to as an autonomous facility for brevity. As described in more detail below, the planning, development, provisioning, operation, and maintenance of the autonomous facility can be carried out by a group of interconnected devices. These interconnected devices can be configured to communicate, coordinate, and carry out the activities needed to create and operate the autonomous facility.

For example, a control station can collect information from sensors of various devices maneuvering through a geographic area, determine what actions need to be taken to achieve a given (desired) state of the autonomous facility, and deploy other devices to perform the actions that are needed to achieve the given state of the autonomous facility. The actions that are determined to be needed can include actions such as, identifying optimal locations for installation of components of the autonomous facility, conditions that may result in future equipment failure, but are not usually identified until after a failure occurs, and changes in vegetation growth that need to be mitigated (e.g., the vegetation needs to be cut or otherwise eliminated). Implementing the autonomous facility in the manner described herein can result in a more efficient autonomous facility that uses less energy, maintains more optimal performance of equipment within the facility, and can lead to a higher level of power output than that achieved by facilities that do not utilize the techniques discussed herein.

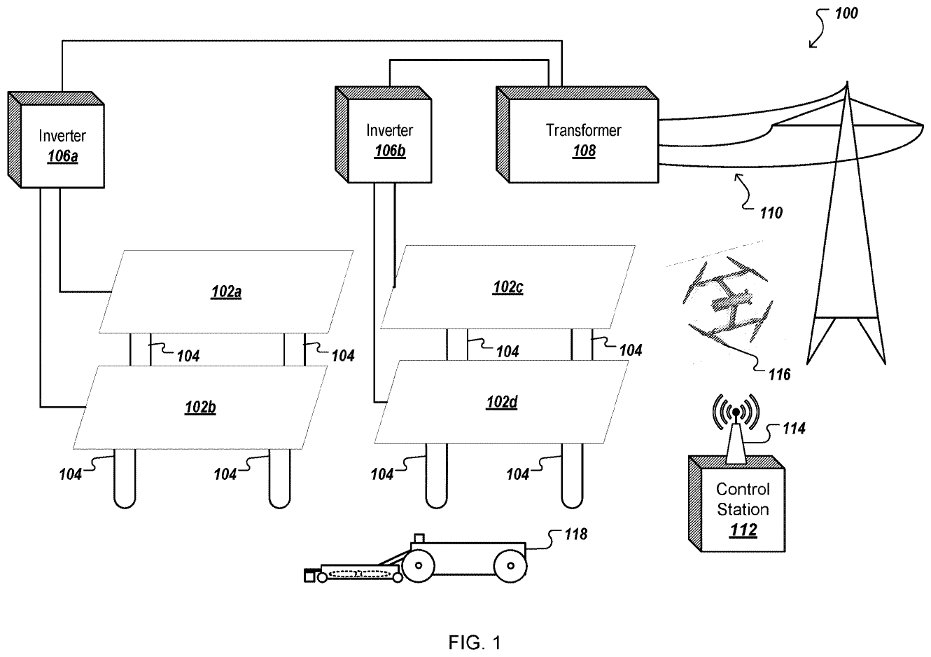

FIG. 1 is an illustration of an example solar field 100. The solar field 100 includes solar panels 102a, 102b, 102c, and 102d, which are arranged in a grid pattern. The solar panels 102a-102d are usually angled to face the sun, either by tilting the panel into a fixed position or by using a tracking system that follows the sun's movement during the day to maximize the amount of sunlight hitting the panels and generate as much energy as possible. To facilitate movement of the solar panels 102a-102d, the solar panels 102a-102d can be rotationally mounted on support structures 104 so that the solar panels 102a-102d can be rotationally repositioned to track the location of the sun.

Each of the solar panels 102a-102d is connected (e.g., electrically connected) to one of the inverters 106a or 106b. Inverters are used in a solar field to convert the direct current (DC) produced by the solar panels into alternating current (AC) that can be used by homes, businesses, and the power grid. The inverters in a solar field can be connected to multiple solar panels and are configured to handle large amounts of DC voltage (e.g., 1000-1500V, or another amount of voltage). The inverters 106a and 106b are configured to convert the DC voltage into AC voltage.

The inverters 106a and 106b can perform several other functions in the solar field 100. For example, the inverters 106a and 106b can monitor the performance of the solar panels 102a-102d, and adjust the output of the system with the goal of maximizing the amount of power being produced by the solar field 100. The inverters 106a and 106b can also be configured to (e.g., include electronic components that) provide safety features such as overvoltage protection, overcurrent protection, and grounding to prevent damage to the system and ensure the safety of any people working on or near the system.

The inverters 106a-b are connected (e.g., electrically connected) to the transformer 108. The transformer 108 is configured to convert the voltage level of the AC power produced by the inverters 106a-b to a level that is suitable for distribution and transmission through the power grid. In some situations, the transformer 108 can step-up the voltage of the AC power received from the inverters 106a-b to hundreds or even thousands of kilovolts to facilitate efficient transmission of the power over transmission lines 110.

The solar field 100 also includes a control station 112. The control station 112 is shown as being co-located with the solar panels 102a-102d (e.g., located in the solar field 100), but some or all of the components of the control station 112 could be at a remote location, such as a mile away from the solar panels or even thousands of miles away from the solar panels. The control station 112 can be a structure that houses computer equipment configured to execute one or more applications that automate the development and/or operation of the solar field 100. The control station 112 can also include a communications interface that enables the control station 112 to communicate with various devices within the solar field 100. For example, as shown in FIG. 1 the control station 112 can include a wireless communication transceiver 114 configured to wirelessly connect to and/or communicate with other devices in the solar field 100. Of course, the control station 112 can include hardwire communication interfaces (e.g., electrical and or optical).

As discussed in more detail below with reference to the other figures, the control station 114 can communicate with various autonomous devices, such as a drone 116, an autonomous mower 118, autonomous trucks, or other autonomous devices to facilitate the installation, operation, and maintenance of the solar field 100 in an autonomous manner. As used herein, the word autonomous refers to the ability of a device to operate without direct human control. For example, the autonomous mower 118 can be a mower that is capable of navigating the solar field 100 without a human operator, and cutting vegetation within the solar field 100. More specifically, the control station 114 can be configured to communicate with the autonomous mower 118 (e.g., wirelessly), to deploy the mower 118, instruct the mower what area of the solar field needs vegetation cut, and receive data back from the mower 118 (e.g., using a camera or other sensors installed on the mower 118) to update information stored about the solar field (e.g., physical conditions detected by the mower 118 in the solar field), and/or adjust the instructions provided to the mower 118 and/or other devices.

The control station 114 can also be configured to deploy the drone 116 (also known as an unmanned aerial vehicle), instruct the drone where to navigate, and instruct the drone regarding the data to be collected by the drone 116. The drone 116 can be equipped with cameras, geographic positioning sensors (GPS), light sensors, moisture sensors, thermal sensors, or other appropriate sensors, as well as other payloads that allow the drone 116 to perform a wide range of tasks within the solar field 100. For example, the drone 116 can be used for aerial photography, surveying, mapping, monitoring vegetation, monitoring wildlife, and delivering items to locations within the solar field 100, or elsewhere.

The drone 116 can also be equipped with a LIDAR (Light Detection and Ranging) device to collect 3D information about the solar field 100. For example, the LIDAR sensor on the drone 116 can collect 3D information to create a 3D map of the geographic location of the solar field 100. More specifically, a scanning mechanism of the LIDAR sweeps a laser beam across an area, and measures the distance to all objects within the field of view. By repeating this process rapidly, the lidar can build up a highly detailed 3D point cloud that accurately represents the shape and position of objects in the environment. Each point in the 3D point cloud will include depth information as well as x and y coordinates, such that the respective heights and/or distances between items detected by the LIDAR can be determined. This can be beneficial, for example, in determining when vegetation has reached a height at which it needs to be cut.

In addition to distance measurements, LIDAR can also be used to gather information about the reflectivity and spectral properties of objects in its path. This can provide additional information about the material composition and surface properties of objects, which can be useful for applications such as terrain mapping, vegetation analysis, and object detection. For example, this information can enable the identification of burn marks or cracks in the solar panels 102a-102d.

In some implementations, the area to be scanned (e.g., using the LIDAR or other sensors on the drone) can be controlled by the control station 112. For example, the control station 112 can be configured to collect data from the solar panels 102a-102c, the inverters 106a-b, the transformer 108, the mower 118, and other devices in the solar field. Using the data collected, the control station 112 can determine the likelihood that the current state of the solar field 100 is not a target/desired state and/or a likelihood that a future state of the solar field 100 is not the target/desired state. In response to determining that current state or future state of the solar field 100 will not be the target state (e.g., with a specified level of certainty), the control station 112 can deploy a given device and instruct the given device to modify one or more aspects of the solar field to maintain the target state or return the solar field to the target state.

In a specific example, assume that the data collected by the drone 116 indicates the height of vegetation in the area of the solar panels 102a-102d. In this example, the control station 114 (or the drone 116) can compare the height of the vegetation to a threshold height (e.g., 6 inches or some other specified height), to determine whether the height of the vegetation is within the target state (e.g., under the threshold height). In response to determining that the height of the vegetation is higher than the threshold height, the control station 113 can conclude that the vegetation is too high, and that the current state of the solar field 100 is outside of the target/desired state.

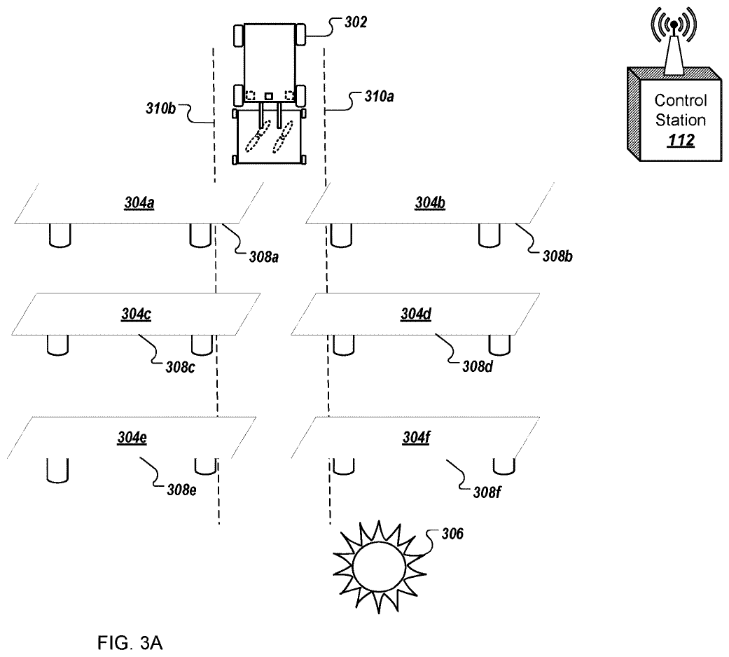

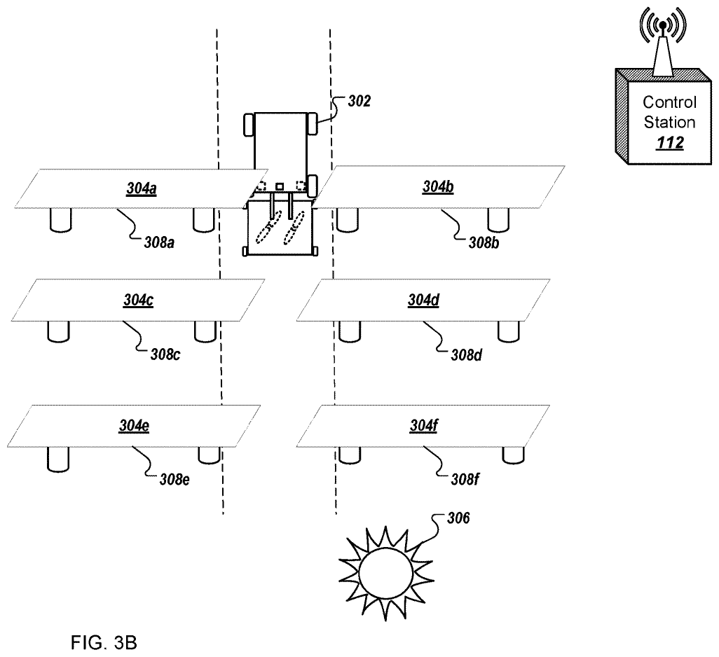

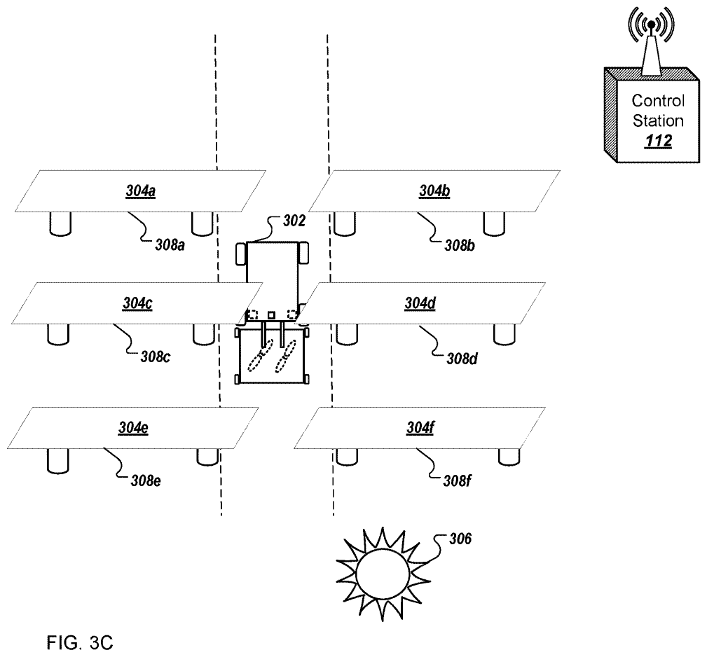

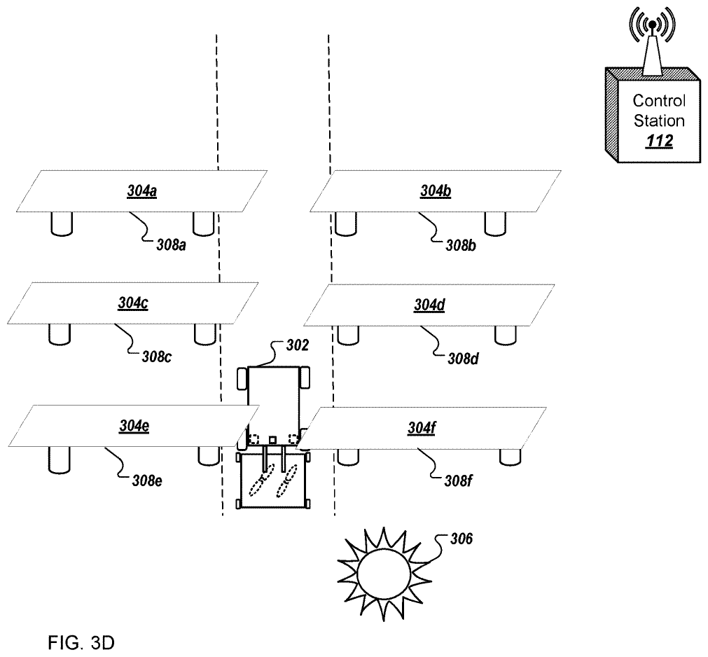

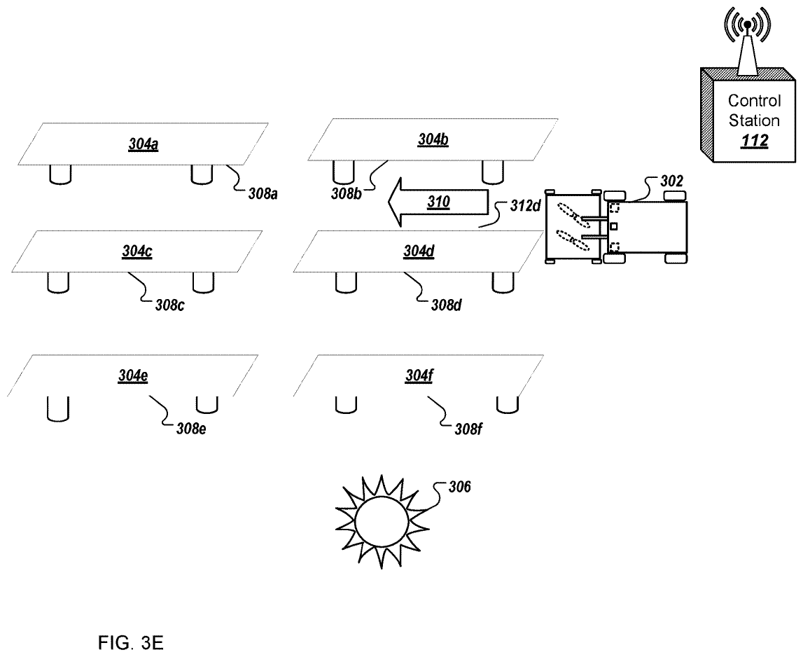

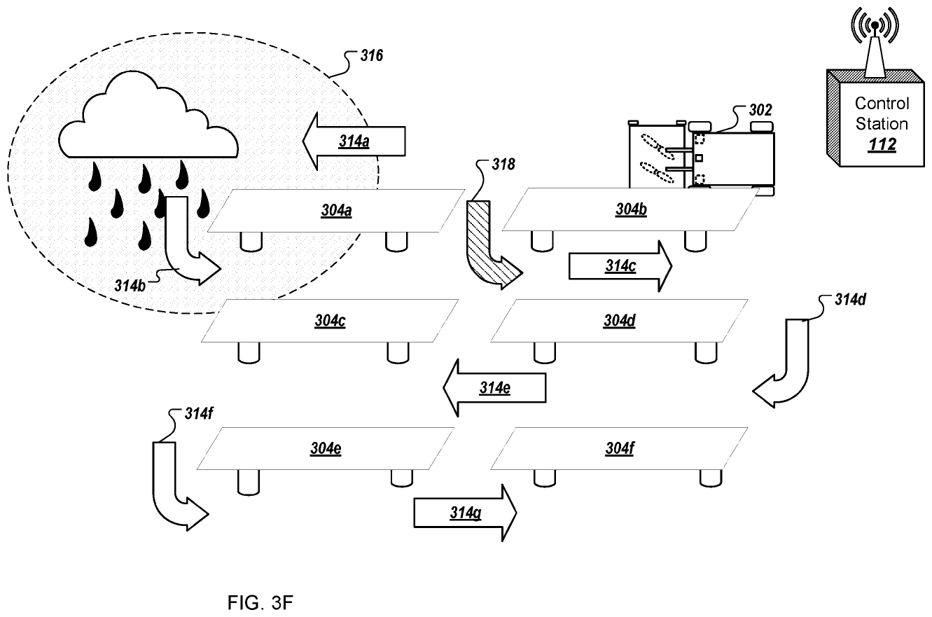

To return the state of the solar field 100 to the target/desired state in this example, the control station 112 can deploy the mower 118 to the location of the vegetation, and cause the mower 118 to cut the vegetation. More specifically, the control station 112 can process the collected data, and generate a set of instructions that define the area of vegetation to be cut by the mower 118, cause the mower 118 to travel to that area, and cause the mower 119 to engage its mower blade. In some implementations, the instructions created by the control station 112 can specify a path that the mower must take, but in some implementations, the instructions created by the control station 112 can simply define the area to be mowed, and the mower 118 can use a GPS sensor (and/or other sensors) installed on the mower 118 to navigate to the area specified by the control station 112, as discussed in more detail with reference to FIGS. 3A-3F.

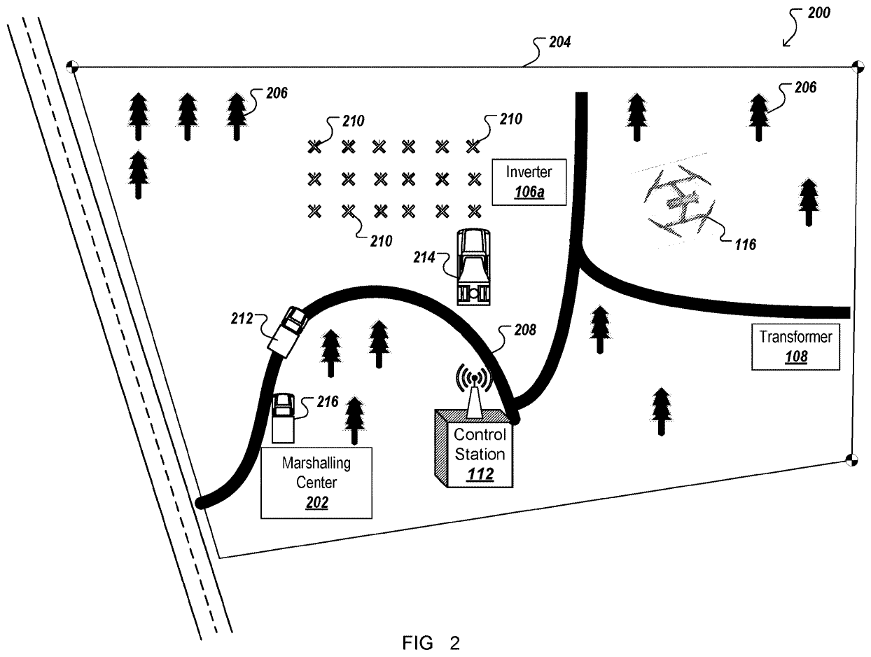

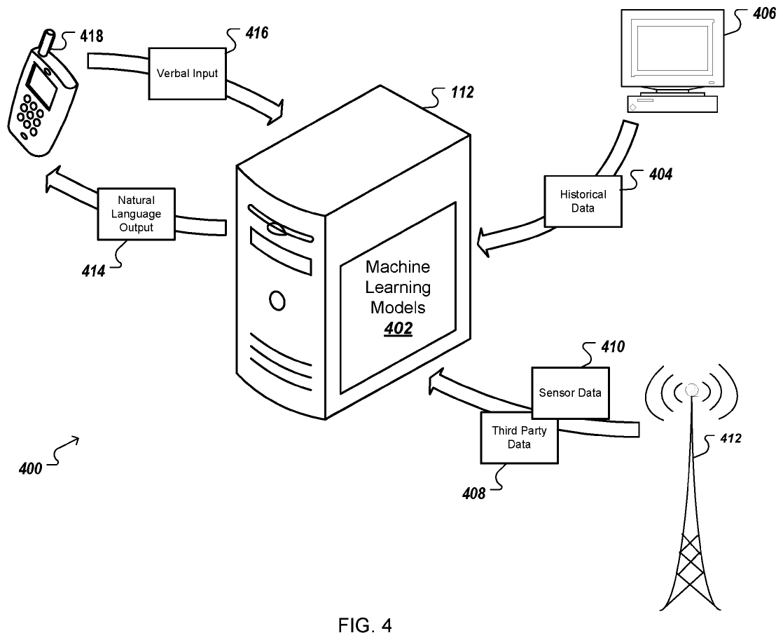

As will be discussed in more detail throughout this specification, the control station 112 coordinate the operation of many different devices to automate many, if not all, of the planning, construction, operation, and maintenance of the solar field 100, or other energy generation locations. For example, FIG. 2 will discuss how the control station 112 can address the planning and construction of the solar field 100. FIGS. 3A-3G will discuss more details of the operation and maintenance of the solar field 100 that can be performed by the control station 112. FIG. 4 discusses more details of the computing device(s) used to implement the control station 112

FIG. 2 is an illustration of an aerial view 200 of a solar field, such as the solar field 100 of FIG. 1. The ariel view 200 shows geographic locations of the control station 112, inverter 106a, and the transformer 108. Although the physical location of the control station 112 is shown in the arial view 112, the control station 112, and/or one or more computing devices, can be located at another location prior to completing construction of the solar field and/or after completing construction of the solar field.

The arial view 200 also shows the location of a marshalling station 202. As used herein, the phrase “marshalling station” is used to refer to a location where materials are delivered, sorted, and/or stored until the materials are needed. In the present example, the marshalling station 202 can function as the delivery location for materials used to construct the solar field depicted in the arial view 200. The marshalling station 202 can also function as the delivery/distribution location for materials used to operate and maintain the solar field after construction of the solar field has been completed. For example, the marshalling station 202 can be used as a storage and staging area for equipment and materials needed during construction of a solar field, such as solar panels, trackers, and mounting hardware, as well as to load and unload construction materials, such as concrete, steel, and electrical components. In some situations, the marshalling station 202 can also house various autonomous vehicles that are controlled by the control station 112.

In some implementations, the control station 112 (or computing devices that are not yet part of the control station) can create a map depicting the arial view 200 based on a combination of collected data and layout preferences/constraints. For example, initially, the control station 112 can receive, as input geographic information (e.g., GPS coordinates, latitude/longitude information, plat number, address, geographic information system (“GIS”) information, or other information) that defines a boundary 204 of the geographic location on which the solar field will be constructed.

Using this information, the control station 112 can generate a set of instructions that cause the drone 116 to be deployed to the geographic area that is within the boundary 204, and perform a scan of the geographic area within the boundary 204. For example, as discussed above, the control station 112 can instruct the drone to capture 3D data of the area within the boundary 204, and collect the information obtained by the drone 116 in real time, or after the drone 116 has completed the area scan is complete. In some implementations, the instructions generated by the control station 112 can specify a route to be taken by the drone 116, at least in part. In some implementations, the drone 116 can be pre-programmed to survey an area within a set of boundaries (e.g., the area within the boundary 204) specified by the control station 112. In either case, the data collected by the drone 116 can be provided to the control station 112 for processing.

The control station 112 can use the data collected by the drone 116 to identify locations of each tree 206, elevation changes, and ground conditions. For example, the control station 112 can apply an object identification model to the data collected by the drone 116 to identify various objects located within the boundary 204. More specifically, the object identification model can accept the point cloud as input, and output most likely object categories for different groups of points in the point cloud. Using this output, the control station 112 can create an initial map that includes all of the identified objects, which can be used to plan the layout of components of the solar field.

The object identification model can be, for example, a convolutional neural network (CNN) that is trained using prelabeled sample point clouds. During training, the model learns to recognize patterns and features associated with different object categories. The training process involves inputting the training data to the model, which updates its internal parameters based on the error or loss between its predicted outputs and the actual outputs.

The control station 112 can proceed to plan the layout of the solar field using a set of preferences/constraints that are stored in a memory device. For example, the control station 112 can make a call to the memory device to access a set of parameters that specify the preferences/constraints for the solar field. The preferences/constraints can specify, for example, electrical requirements, such as minimum power generation requirements for the solar field. The preferences/constraints can also specify a set of available materials/vehicles that are available to construct the solar field. The preferences/constraints can include any other factors stored in the memory device that may be helpful in determining the layout of the components within the boundary 204 (e.g., access points to the grid, surrounding road locations, or other relevant information).

The control station 112 can create a layout, for example, by identifying areas that achieve as many of the specified preferences, while working within the specified constraints. For example, if access to transmission lines of the grid are most easily accessible from one side of the boundary 204, arranging the layout of the components to ensure easy access to the transmission lines could cause the control station 112 to place the transformer 108 in a location that facilitates the easy access to the transmission lines. In some situations, the preferences/constraints are ranked in order of importance, such that the control station 112 can make the layout decisions in a weighted fashion, where the higher ranked preferences/constraints are more heavily weighted as the control station 112 creates the layout. In some implementations, the control station 112 can iteratively create multiple layouts and score each layout based on a set of criteria, such as energy production, ease of access to locations by construction/maintenance equipment, or other criteria, and select the layout having the highest score.

As part of creating the layout, the control station 112 can select the geographic locations of the control station 112, the inverter, the transformer 108, the marshalling center 202, and roads 208. The control station 112 can also select the locations of the solar panels (not shown), as well as the specific mounting structure locations 210 for mounting structures on which the solar panels will be installed. The control station 112 can select the specific mounting structure locations 210, for example, to maximize the exposure of the solar panels to the sun after installation.

The determination of the specific mounting structure locations can be made, for example, based on information as to the orientation of the sun relative to the area within the boundary throughout a day and at different times of the year. The determination can also consider the type of mounting structures that will be installed. For example, the specific mounting structure locations can consider whether the mounting structures will be fixed tilt systems, single-axis tracking systems, or dual-axis tracking systems. Fixed tilt systems are stationary and do not move, while single-axis and dual-axis tracking systems are designed to follow the sun's path across the sky to maximize energy production. Furthermore, since these structures are most often anchored to the ground (e.g., a piling foundation), the specific mounting structure locations (e.g., locations of the holes that will be bored in the ground) will depend on the configuration of the specific mounting structures being used.

When the layout of the solar field is created, the control station 112 can initiate the process of modifying the area within the boundary 204 as needed to construct the solar field. For example, the control station 112 can deploy autonomous land clearing/grading devices (e.g., tree cutters, bulldozers, or other devices capable of clearing/grading land), with instructions of the area within the boundary that need to be modified for construction of the solar field. For example, using the layout, the control station 112 can generate instructions that cause these devices to cut trees and grade the land in the areas where the roads 208 are located. The control station 112 can transmit these instructions to the appropriate autonomous devices, which will result in these autonomous devices to be deployed and begin the clearing/grading of the land where the roads 208 are being constructed.

The control station 112 can also communicate with other autonomous vehicles, such as a vehicle configured to lift cut trees and a tree hauling truck 212. The tree lifter and the tree hauling truck can be deployed to the location of the tree cutter during the time the trees will be cut so that the trees can be lifted and placed onto the tree hauling truck 212, and removed from the area. Similarly, the control station 112 can communicate with a tree chipper vehicle and/or a dump truck to navigate these vehicles to the location of the trees being cut so that the trees can be mulched and potentially trucked away as the geographic area is being modified (e.g., trees are being removed).

The control station 112 can also interact with an autonomous auger 214, and deploy the autonomous auger 214 to the area of the specific mounting structure locations 210, and transmit instructions to the autonomous auger 214 that cause the autonomous auger 214 to make holes in the ground at the specific mounting structure locations 210. For example, the instructions sent to the autonomous auger 214, can include GPS coordinates of each specific mounting structure location 210, and the autonomous auger 214 can drill holes in the ground at each specific mounting location 210 based on the instructions. In some implementations, the autonomous auger 214 is also configured to create a piling foundation and/or insert a pole of the mounting structure into the ground at each specific mounting location 210. In some implementations, the control station 112 can interact with, and deploy, another autonomous vehicle to create the piling foundation or insert the pole of the mounting structure into the hold created by the autonomous auger 214.

To facilitate the installation of the solar panels, inverter 106a, transformer 108, and structure for the control station 112, the control station 112 can communicate with third party suppliers to have the appropriate materials delivered to the marshalling center 202. For example, the control station 112 can request delivery of the appropriate materials, have autonomous vehicles unload the materials, and arrange them within the marshalling center 202 before they are needed. As the construction of the solar field continues, the control station 112 can instruct the appropriate autonomous vehicle to navigate to the marshaling center 202 to distribute the materials to the appropriate location. For example, when it is time to install the transformer 108, the control station 112 can navigate an autonomous delivery truck 216 to the marshalling center, where autonomous pickers will move the transformer 108 from its stored location within the marshalling station 202 onto the delivery truck 216. The control station 112 can then navigate the delivery truck 216 to the planned installation location of the transformer 108. When the delivery truck 216 arrives at the planned installation location, the control station 112 can instruct an autonomous forklift, or another device, to unload the transformer 108 and set it in place.

The control station 112 can be configured to control other autonomous vehicles and perform other activities required to construct the solar field according to the map, but several examples have been provided above to illustrate the capabilities of the control station 112 in coordinating the movement and operation of various autonomous vehicles to construct a solar field. For example, the control station can obtain a scan of the geographic area, determine how the area needs to be modified to complete construction of the solar field, deploy the appropriate vehicles/machines to make the needed modifications, and collect data back from the vehicles regarding the modifications. The data received regarding the modifications can be stored, for example, in a database that houses the characteristics of the solar field for use in operation and maintenance of the solar field.

The maintenance of a solar field often requires vegetation control, for example, to prevent vegetation from hindering the ability of the solar panels to move and/or collect sunlight. As discussed with respect to FIG. 1, that vegetation control can include using autonomous mowers to areas of the solar field that need vegetation cut, but it can also require coordination of other devices and/or components of the solar field. For example, when trackers are used, the orientation of the solar panel changes, which changes the height of at least one edge of the solar panel from the ground. This elevation change can prevent devices, such as an autonomous mower, from being able to navigate near the solar panel due to a low clearance between the ground and the edge of the solar panel. To address this issue, the control station 112 can coordinate the movement of devices through the solar field with movement of the solar panels, for example, by moving the solar panels to allow the movement of the devices.

FIG. 3A is an illustration of an autonomous mower 302 approaching a set of solar panels 304a-304f. As shown in FIG. 3A, trackers that control the orientation of the solar panels 304a-304f have tilted the solar panels 304a-304f toward the sun 306, which has lowered the front edges 308a-308f of the solar panels 304a-304f to a height that prevents the mower 302 from traveling under the solar panels 304a-304f along a path defined by the dashed lines 310a and 310b. To enable the mower 308 to move along the path under the solar panels 304a-304f, the control station 112 can monitor the location of the mower 302, and when the mower 308 is within a specified distance (e.g., a geo-fence) of the solar panels 304a-304f, the control station 112 can remotely adjust the orientations of the solar panels 304a-304f. For example, the control station 112 can engage (e.g., initiate movement of) the tracker that controls the orientation of the solar panels, and raise the front edges 308a-308f of the solar panels 304a-304f at least enough to provide sufficient clearance for the mower (or another device) to navigate under the solar panels 304a-304f.

FIG. 3B is an illustration of the autonomous mower 302 navigating under solar panels 304a-304b. In FIG. 3B, the engagement of the tracker by the control station 112 has adjusted the tilt angle of the solar panels 304a-304b so that the front edges 308a-308b of these solar panels 304a-304b to be higher off the ground than the front edges 308c-308f. The increased height of the front edges 308a-308b enables the mower 302 (or another given device) to navigate under the solar panels 304a-304b, thereby allowing the vegetation under those solar panels 304a-304b to be cut, without having to adjust the other solar panels 304c-304f.

As the mower 302 continues to navigate along the path, it will emerge from under the solar panels 304a-304b, and approach the solar panels 304c-304d. As the mower 302 continues its navigation, the control station 112 can continue to monitor the movement of the mower 302, and engage trackers to make appropriate adjustments to the orientations of the solar panels 304a-304f to enable movement of the mower 302 under the solar panels 304a-304f. FIG. 3C is an illustration of the autonomous mower 302 navigating under solar panels 304c-304d after it has passed the solar panels 304a-304b.

In FIG. 3C, the control station 112 has again engaged the trackers of solar panels 304a-304b to again tilt these solar panels 304a-304b toward the sun 306. The control station 112 has also engaged (e.g., activated) the trackers for solar panels 304c-304d to adjust the tilt angle of the solar panels 304a-304b so that the front edges 308c-308d of these solar panels 304c-304d are higher off the ground than the front edges 308a, 308b, 308d, 308f of the other solar panels 304a, 304b, 304d, 304e. As discussed above, the increased height of the front edges 308c-308d enables the mower 302 (or another given device) to navigate under the solar panels 304c-304d, thereby allowing the vegetation under those solar panels 304c-304d to be cut, while allowing the other solar panels 304a, 304b, 304e, 304f to be angled toward the sun 306.

As shown in FIG. 3D, which is an illustration of the autonomous mower 302 navigating under solar panels 304e-304f after it has passed the solar panels 304c-304d, the control station 112 can operate in a similar fashion to return solar panels 304c-304d to a tilt angle facing the sun 306 when the control station 112 detects that the mower 302 has cleared the solar panels 304c-304d, and engage the trackers of solar panels 304e-304f to raise the front edges 308e-308f to enable the mower 302 to navigate under the solar panels 304e-304f. This sequential reorientation of the rows of solar panels (e.g., 304a and 304b, 304c and 304d, 304e and 304f) can be referred to as a wave sequence.

The control station 112 can also adjust the rows of solar panels in a similar manner when the mower 302 (or another device) is navigating across columns/along rows of solar panels. FIG. 3E is an illustration of the mower 302 navigating across columns of solar panels 304a-304f. As shown, the mower 302 is approaching the solar panels 304b and 304d from the right, and navigating in the direction of the arrow 310. In this example, the control station 112 can detect, based on location monitoring and/or geofencing, that the mower 302 is approaching these two solar panels 304b and 304d, and determine the current orientation of the solar panels 304b and 304d. For example, based on signals transmitted to the control station 112 by the trackers for these solar panels 304b and 304d, the control station 112 can determine, prior to adjusting the tilt of solar panel 304b as shown, that the rear edge 312d of the solar panel 304d is elevated above the height of the mower 302 (e.g., based on the tilt angle of the tracker for solar panel 304d), and the front edge 308b of the solar panel 304b needs to be raised (as shown) to provide clearance for the mower 302. In this example, the control station 112 can engage the tracker for the solar panel 304b to adjust the tilt angle of the solar panel 304b, thereby providing clearance for the mower 302 to navigate under the solar panel 304b.

As illustrated, the control station has not yet adjusted the orientation of the solar panel 304a, but it could also be adjusted at the same time as, or shortly after, the adjustment to the orientation of the solar panel 304b in anticipation of the mower 302 navigating under the solar panels 304a-304c. For example, the control station 112 can use a combination of one or more of a speed of the mower 302, a distance of the mower 302 from the solar panel 304a, and an amount of time required for the tracker to raise the front edge 308a of the solar panel 304a above the height of the mower to determine when to engage the tracker of the solar panel 304a so that the angle of the solar panel 304a is adjusted for as little time as possible, thereby optimizing the solar collection of the solar panel 304a—e.g., reducing lost solar collection caused by changing the angle of the solar panel 304a.

FIG. F is another illustration of the autonomous mower 302 navigating under solar panels 304a-304f. In this illustration, the mower 302 has been deployed by the control station 112 to follow a specified path identified by the arrows 314a-314g. For example, the control station 112 can generate instructions specifying the path identified by the arrows 314a-314g, and transmit, to the mower 302, the instructions along with any additional code required (e.g., API commands) to cause the mower 302 to navigate the path identified by the arrows 314a-314g.

As the mower 302 travels along the designated path denoted by the arrows 314a-314g, the mower 302 can use various sensors to inspect the surrounding environment to determine if any modifications need to be made to the geographic area to achieve a desired state. In other words, the mower 302 can act as a scout to determine what changes may need to be made to the solar field based on any actionable conditions the mower 302 detects as it travels around the solar field. For example, if the mower 302 is outfitted with a LIDAR sensor, it can scan the area as it maneuvers to collect information about the geographic area and/or equipment it passes. This information can be processed, either by the mower 302, the control station 112, or another device, and used to determine aspects of the solar field that need to be modified for the solar field to be within specified operating conditions, which is a desired state. In some implementations, the mower 302 reports any actionable condition to the control station 112, which causes various devices to perform operations that resolve the actionable condition.

In a specific example, as the mower 302 navigates past the solar panel 304b, the mower 302 can scan the area to collect images, thermal information, or other information about the solar panel 304b and its surrounding environment. This collected information can be processed and used to identify, for example, vegetation growing up the support structures of the solar panel 304b, physical/chemical deterioration of the support structures of the solar panel 304b, or cracks in the support structures of the solar panel 304b or in the solar panel 304b itself. Similarly, the collected information can be used to identify burn marks in the solar panel 304b (e.g., using an object detection algorithm trained to identify burn marks), which can indicate a problem with the solar panel 304b that is not yet detectable based on other signals collected regarding the solar panel 304b (e.g., information about its electrical output), and is generally not detectable until a complete failure of the solar panel 304b. By detecting such an issue prior to a complete failure, the issue can be resolved (e.g., the solar panel can be repaired or disabled/replaced) to avoid a complete failure, thereby making the solar field more reliable, efficient, and effective. It can also mitigate risks that may be caused by a complete failure, such as fires or power production outages. For example, in response to detecting

To correct the issue, the control station 112 can use the collected information to determine a modification (e.g., maintenance, repair, or replacement) required to be made to resolve the issue, thereby achieving a target state, such as a normal operating state. Based on the required modification, the control station 112 can determine one or more devices that need to be used to complete the required modification, and deploy those one or more devices to the location of the issue (e.g., the solar panel 304b) to make the modification.

For example, assume that the control station 112 determines that vines are growing up the solar panel 304b, and that those vines need to be cut, or otherwise destroyed (e.g., using herbicides) to achieve the normal operational state. In this example, the control station 112 can deploy an autonomous device that is equipped with a vine cutting mechanism and/or an herbicide spraying mechanism to the location of the solar panel 304b. Executing the instructions provided by the control station 112, the autonomous device can navigate to the location of the solar panel 304b, and cut, spray, or otherwise remove the vines, or other vegetation, growing up the solar panel 304b.

Another example of an actionable condition that the mower 302 (or another autonomous device) can detect and report to the control station 112, is the detection of a characteristic of an object that is not accurately represented in a database storing characteristics of objects located in the solar field (or another geographic location). For example, as the mower 302 approaches the solar panel 304, the mower 302 can use its GPS sensor to determine that the support structure (e.g., a post) of the solar panel 304b is not in the recorded location for that support structure. To illustrate, assume that the support structure was originally planned for installation at coordinates 33.849356507228784, −84.29925850080242, but that the mower 302 detects the post is actually installed at coordinates 33.84930200530447, −-84.29906509344893, such that the actual location of the support structure does not match the stored location of the support structure, and the stored location of the does not accurately represent the location of the support structure. In this example, the mower 302 or the control station 112 can update the database to resolve the discrepancy, for example, by storing the detected location of the support structure to reflect the detected location of the support structure. Of course, similar updates to the database can be made to update the detected location of any other objects that are detected in the solar field.

Returning to the navigation of the mower 302 along the planned path designated by the arrows 314a-314g, the mower 302 can collect terrain data characterizing the terrain it encounters, and report that terrain data back to the control station 112, or use the terrain data itself. In some implementations, the terrain data is used to update the navigation path of the mower 302 (or another device) to avoid obstacles that may not have been known to the control station 112 at the time the original navigation path was created.

For example, assume that the mower 302 encounters a wet area 316, or another obstacle such as a downed tree, that will interfere with navigation of the mower 302 along the path designated by the arrows 314a-314g. In this example, the mower, or the control station 112, can generate an alternative navigation path that reduces the interference of the wet area 316, or another obstacle, with the navigation of the mower 302. As shown, the alternative navigation path can cause the mower 302 to follow the arrow 318, which will bypass the wet area 316, and allow the mower 302 to rejoin the original navigation path at the arrow 314c, and then complete the rest of the original navigation path. In this way, the collection of the terrain data enables the mower 302 and the controls station 112 to dynamically react to real world conditions that may prevent the original plans to be completed.

By enabling dynamic modifications to planned actions/operations of autonomous devices to avoid obstacles that would otherwise prevent completion of the intended tasks, the system is more efficient by enabling the autonomous devices to carry out at least a portion of the intended tasks rather than simply aborting the mission. For example, the autonomous devices will have used significant amounts of power (e.g., batter power or fuel) in navigating to the area to be modified (e.g., vegetation cut, etc.), all of which will be wasted if the mission is completely cancelled due to an isolated obstacle that is encountered during navigation.

In some implementations, construction, operation, and/or maintenance of the solar field (or another geographic area) can be performed based on output of one or more machine learning models trained to predict various events, and generate an optimal construction, operation, and/or maintenance plan based on the event predictions. In some implementations, the machine learning model can be implemented as part of an artificial intelligence system that is capable of deciphering natural language inputs (text or speech), making decisions based on application of the machine learning model based on the natural language inputs, and create action plans to complete tasks required for the construction, operation, and/or maintenance of the solar field.

FIG. 4 is a diagram of an environment 400 in which machine learning models 402 can be implemented. The environment includes the control station 112, which is depicted as a computer system, but of course, can include other components as well, including specially created and/or programed circuitry configured to implement the machine learning models to facilitate fast learning and decision making.

To facilitate the training and execution of the machine learning models 402, the control station 112 can be configured to obtain historical data 404 from one or more computing systems 406. This historical data can include various types of data including weather data, power outage data, solar panel maintenance and failure data, signals collected prior to failure events (e.g., electrical characteristics of solar panels prior to failure of a solar panel), battery consumption by various autonomous devices during various activities, and other historical data.

The machine learning models 402 can be trained, for example, using one or more of supervised learning, unsupervised learning, or reinforcement learning. In some implementations, the historical data 404 is formatted to facilitate supervised learning. In these implementations, the historical data 404 is labeled and segmented into (i) a training set and (ii) a testing set that can be used to evaluate the performance of the machine learning models 402 and adjust the parameters of the machine learning models 402 with the goal of minimizing the prediction errors of the machine learning models 402. In some implementations, the historical data 404 is used in unsupervised learning, where the historical data 404 can be clustered and the machine learning models can determine the structure of the data without labels, and adjust the parameters of the model based on the structure of the data. The model can then be used new data based on its features when the new data arrives.

In a specific example, the machine learning models 402 can be trained to predict vegetation growth in a solar field and generate a proposed vegetation management plan based on the predicted vegetation growth. The vegetation growth can be predicted for example, based on historical data related to vegetation growth in the geographic area of solar field. The prediction can also take into account third party data 408, such as weather forecasts, sensor data 410, such as temperature, humidity, and/or rain total information collected in the solar field, and/or vegetation management activity (e.g., herbicidal deployment) that has occurred and/or is planned for the solar field. The third-party data 408 and sensor data 410 can be obtained, for example, from a wireless communications network 412 that connects the control station 112 with third party data sources (e.g., weather organizations) and sensors deployed in the solar field.

Using this information as input, the machine learning models 402 can determine the expected vegetation growth for future time period, and generate the proposed vegetation management plan. The vegetation management plan can include the timing and method of vegetation control that will be performed over the future time period. For example, the vegetation management plan can specify vegetation cutting schedules for different subsections of the geographic area based on differences in predicted vegetation growth in those different subsections. The control station 112 can then output instructions that cause deployment of one or more autonomous devices to the different subsections of the geographic area according to the vegetation management plan.

In some implementations, the control station 112 can create an initial vegetation management plan that is modified as conditions change. For example, the control station 112 can use the information collected by the autonomous devices navigating through the geographic area (e.g., as discussed above with respect to the mower 302), and adjust the vegetation management plan based on actual conditions in the geographic area. For example, if data collected by an autonomous device navigating through the geographic area reveals that the vegetation growth is lower than originally predicted, the control station 112 can use this information to delay deployment of autonomous vehicles as planned in the original vegetation management plan. In this type of situation, the control station 112 can also use the newly collected information to adjust the machine learning models 402 in an effort to improve the accuracy of the machine learning model.

The machine learning models 402 can also be trained to predict maintenance schedules for electrical and/or structural components installed in the solar field. For example, the historical data 404 can include information related to operational characteristics of the components, failure rates of the components in environments similar to environment in which the components are currently installed, and/or other information that is useful in creating a maintenance plan for the installed components. Similar to the vegetation management plan, the maintenance plan for the installed components can be updated or otherwise modified based on data collected during operation of the solar field.

For example, assume that sensors deployed in the solar field (e.g., connected to components installed in the solar field, or attached to an autonomous device navigating through the geographic area) provide sensor data 410 reflecting current operational characteristics of the installed components. In this example, the sensor data 410 can include information indicative of one or more of (i) an out of tolerance temperature reading on a solar panel, (ii) burn marks, (iii) electrical arcing, (iv) a crack in a solar panel, or (v) a ground fault that has not caused a solar panel failure condition. In response to receiving this sensor data 410, the control station 112 can trigger a visible or audible alarm, navigate an autonomous device to the location at which the sensor data was collected, and/or disable the solar panel.

In this situation, the sensor data 410 as well as mitigation activity and the ultimate outcome can be used to update the machine learning models 402, and modify the maintenance plan accordingly. For example, if the solar panel is ultimately replaced, the control station 112 can update the maintenance plan to cancel upcoming scheduled maintenance for the solar panel that was removed, and create scheduled maintenance based on the characteristics (e.g., age, electrical performance, environmental conditions) of the newly installed solar panel.

The control station 112 can be configured to provide various natural language outputs 414 (e.g., text or speech). For example, the control station 112 can be configured to accept and process natural language input 416 (e.g., text or speech), determine the intent of the natural language input 416, and generate the natural language output 414 that provides appropriate answers to the natural language input 416.

In some implementations, the control station 112 can include a generative model, such as a Large Language Model (LLM), that uses a transformer architecture, which allows the LLM to process and generate sequences of words or sentences. The transformer architecture is composed of multiple layers of self-attention mechanisms, which enable the model to focus on different parts of the input sequence at different depths of the network. This makes it possible for the model to capture long-term dependencies and complex linguistic relationships between words.

The use of large language models (or other natural language models) enables the control station 112 to interact with a human (or virtual entity), for example, over a phone 418 or the Internet, provide requested information, such as solar field status information, and/or take action based on spoken input, in a conversational manner. This is particularly helpful when a solar field is configured in an autonomous manner and is remotely located (e.g., hundreds of miles from a town, making it difficult to travel to the solar field and/or determine the current status of the solar field.

For example, assume that an error condition is detected by the control station 112, but the automation of the control station 112 is unable to correct the error condition. In this example, the control station 112 can be configured to call the phone 418, and explain the nature of the error and mitigation efforts already taken in a conversational manner. The person (or automated system) that receives the phone call can determine a proposed action to be taken by the control station 112, and respond to the control system 112 with verbal input 416 explaining the actions the control station 112 should take. The control station 112 can process this input, make various determinations (e.g., whether the proposed action has already been performed, outcome of performing the proposed action, request additional instructions, or generate alternative proposed actions), and respond to the verbal input 416 with natural language output 414 acknowledging that the proposed action will be performed, describing the outcome of performing the proposed action, or providing further information related to the proposed action (e.g., asking questions or making suggestions regarding performing the proposed action) in a conversational manner. In this way, the control station 112 can obtain additional information, or request assistance, for example, when the machine learning models 402 predictions may not have a high enough level of confidence to take action without confirming the action to be taken. In some implementations, the interactions can be used to refine or update the LLM to further enhance the ability of the LLM to communicate effectively.

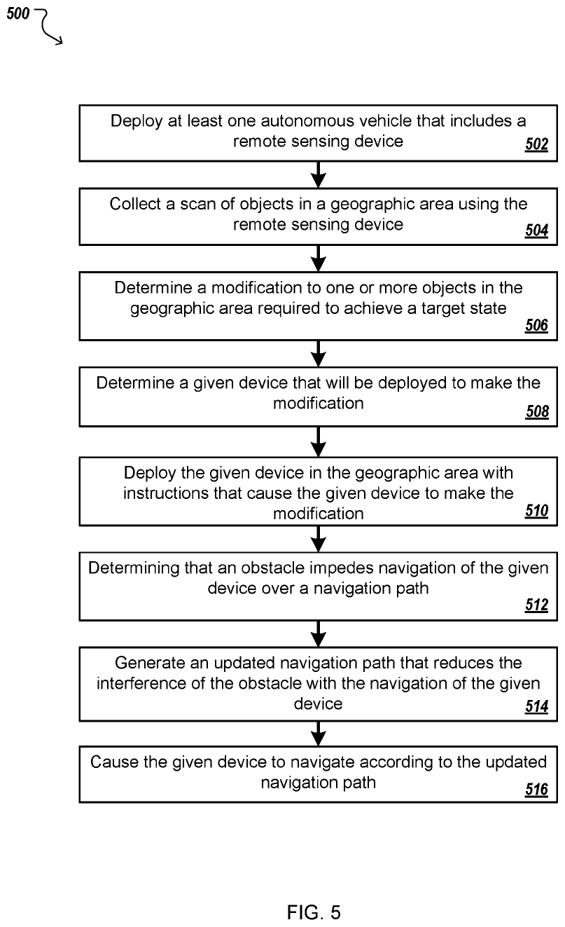

FIG. 5 is a flow chart of an example process 500 of autonomously modifying a geographic area. Operations of the process 500 can be implemented, for example, by the control station 112 discussed above, and/or other computing devices, including specially programmed/configured devices. Operations of the process 500 can also be implemented as instructions stored on one or more non-transitory computer readable medium, where execution of the instructions cause one or more computing devices to perform operations of the process 500.

At least one autonomous vehicle is deployed (502). In some implementations, the autonomous vehicle can include a remote sensing device configured to collect data about objects in a geographic area. For example, the autonomous vehicle can include a LIDAR, radar, thermal, or another sensor configured to collect data about objects in a geographic area. The autonomous vehicle can be, for example, a drone (e.g., an unmanned aerial vehicle) configured to aerially traverse the geographic area. In this example, the drone can be equipped with a LIDAR sensor that enables the drone to collect three-dimensional data about objects in the geographic area.

The at least one autonomous vehicle can be deployed by the control station 112 discussed above, or another computing device. For example, the control station 112 can provide the drone with information from which a boundary of the geographic area to be scanned can be determined, and instruct the drone to traverse the geographic area to collect data on the objects within the boundary.

In some implementations, the deployed autonomous vehicle can be a mower, all-terrain vehicle (ATV), truck, or another autonomous vehicle. The autonomous vehicle can be an electrically powered vehicle that is plugged into a power source to charge while it is not deployed. When the autonomous vehicle is deployed, it can disconnect from the power source, and navigate according to deployment instructions provided by the control station, as discussed in more detail below. When using battery powered vehicles, managing battery life can be an important consideration, and the control station can utilize battery consumption characteristics of the autonomous vehicle in planning the deployment and/or route of the autonomous vehicle to maximize the work completed by the autonomous vehicle and/or select a route that will reduce the battery drain (e.g., going around a large hill, rather than climbing it).

In some implementations, deployment of the autonomous vehicle can include the control station 112, or another device, causing the autonomous (e.g., self-driving) vehicle to navigate along a specified path within a geographic area, and perform various tasks/functions. For example, the deployment instructions provided to the autonomous vehicle can include a navigation path and a set of actions to be performed by the autonomous vehicle. The actions to be performed can be one or more of installing posts into the ground, placing solar panels onto support structures, securing the solar panels to the support structures, making electrical connections between the solar panels, installing power poles to support conductors, installing conductors between the power poles, connecting the conductors to transmission lines of the grid, cutting vegetation to less than a specified height, cutting vines, cutting branches, cutting shrubs, cutting trees, cleaning installed solar panels (or other equipment), moving objects from one location to another, grading soil, watering plants, extinguishing detected fires, preventing fires in areas that are dry and hot by spraying those areas with water, spraying herbicide on plants, among other tasks.

A scan of objects in a geographic area is scanned using the remote sensing device (404). In some implementations, the collection of the scan can include collecting LIDAR data and generating a LIDAR mapping of the geographic area, which can be an area for a proposed/candidate solar field or wind power field. For example, the LIDAR sensor on the autonomous vehicle can collect the LIDAR data as the autonomous vehicle traverses the area of the geographic location, and create the LIDAR mapping, which can then be processed (e.g., using object detection algorithms) to create a three-dimensional mapping of the geographic area. In some situations, objects in the LIDAR mapping can be labeled, for example, to identify different types of vegetation (e.g., trees, shrubs, protected species, soil conditions, standing water, etc.).

In some implementations, collection of the scan can be performed using other sensors, such as temperature sensors, cameras, humidity sensors, electrical sensors, or other sensors. The collection of the scan can also be performed while the autonomous vehicle is deployed to perform another task. For example, as discussed above, when a mower is deployed to cut vegetation, it can collect data along its travel path regarding the objects it passes and the land it traverses. This collected data can be reported back to the control station 112, and processed to determine what other tasks may need to be performed, as previously discussed.

A modification to one or more objects in the geographic area required to achieve a target state of the geographic area is determined (506). The target state is a specified state of the geographic area that is to be achieved or maintained. The modifications that are required to achieve the target state can be determined, for example, by analyzing the collected scan of the geographic area. Irrespective of whether the collected scan is an initial aerial scan of the geographic area or a scan collected by an autonomous vehicle traversing the geographic area to complete a task as instructed by the control station 112, analysis of the scans can reveal aspects of the geographic area that are not currently in the target (e.g., desired) state, or are at risk of moving outside of the target state.

For example, when construction/installation of a solar field (or another facility) is initially being planned, analysis of the scan can be used to select installation locations for one or more solar field components. As discussed above with respect to FIG. 2, the locations of those components can include locations of a transformer, inverter, control station housing, a marshalling center, support structure (e.g., piling) locations for solar panels, roads, etc. In this example, the locations of these components can be determined, for example, based on soil conditions, tree locations, access points to existing grid infrastructure, and land topology factors that can be learned from the LIDAR mapping created by the drone.

When constructing a solar field, the target state can be defined simply as a functional solar field, but the target state can be more complex depending on the constraints imposed. For example, if the constraints specify a limited set of equipment, a time constraint for completion, or other constraints, those constraints can be considered in determining the target state. In a specific example, assume that the constraints specify that the solar field must be made operational without cutting any trees, such that the target state is an operational solar field that does not require tree cutting. In this scenario, the determination of the modifications to be made to create the operational solar field can exclude tree cutting as a viable modification, and can identify other modifications to the geographic area that will achieve the target state. For example, locations of the solar field components can be selected in a way that prevents the need to cut trees. More specifically, locations of one or more of (i) installation locations for posts configured to support solar panels, (ii) inverters, (iii) transformers, (iv) service roads, or (v) a control station can be planned to avoid existing trees, and locations of the posts (or other support structures) for the solar panels can be selected so that existing trees will not interfere with sun exposer to the solar panels once installed. Once the locations of the components are selected, those can be used to further define the operations (e.g., land grading, road creation, hole digging, etc.) that must be performed to make the solar field operational without cutting trees.

After the solar field is constructed and operational, the modifications to the geographic area required to maintain (or return to) the target state can be determined using data collected by the autonomous vehicles as they traverse the geographic area. For example, a “scout” autonomous vehicle can be instructed to navigate through the geographic area on a periodic basis to scan the geographic area and collect data about the conditions of the solar field irrespective of whether it is also performing another task (e.g., a pre-scheduled task). As discussed above, the data collected through the scan can be used by the control station 112 to identify an out of target state condition or determine that an out of state target condition is likely to happen.

For example, if the scout autonomous vehicle collects data used to determine that vegetation in an area of the solar field is over a specified height (e.g., over a maximum allowed height), the control station can determine that vegetation in that area of the solar field is required to be cut to achieve the target state, which is having vegetation below the specified height. In this example, the determined modification of reducing the vegetation height is determined based on the current height of the vegetation, which revealed that the height of the vegetation was higher than the target sate, but required modifications can also be determined before conditions are outside of the target state. For example, predictive analysis can be performed to generate plans including one or more determined modifications that are required (potentially together or at different times) to prevent the geographic area from leaving the target state.

For example, as discussed above, a machine learning model can be trained to predict vegetation growth using a set of historical data, including at least one of vegetation growth history for the geographic area, vegetation management activity, or weather data. The vegetation growth history for the geographic area can specify, for example, growth rates for different specifies of plants over specified time periods (e.g., days or weeks in the spring, summer, and/or fall). The vegetation management activity can specify how the vegetation has been maintained recently. For example, vegetation management activity can specify when the vegetation was last cut, the height the vegetation was cut to, and any growth inhibiting activity (e.g., herbicidal sprays) or growth accelerating (e.g., fertilizer applications) that were applied to the vegetation. The weather data can include historical weather data, such as the rainfall, temperature, or humidity of the geographic area. The weather data can also include, for example future weather forecasts obtained from meteorological services.

The vegetation growth predictions output by the machine learning model can be used, e.g., by the control station, to generate a proposed vegetation management plan for the geographic area of the solar field. The vegetation management plan can specify, for example, different cutting schedules for different subsections of the geographic area based on differences in predicted vegetation growth in the different subsections.

For example, assume that in a particular subsection of the geographic area has received 6 inches of rain over the past week, while a different subsection of the geographic area has received no rain over the past week. In this example, the vegetation growth predictions may indicate that the vegetation growth in the particular subsection will be 4 inches within the next 7 days, and that the vegetation growth in the different subsection will only be 1 inch in the next 7 days. Given these predictions, the control station 112, can create a vegetation management plan specifying that the particular subsection will be cut in 3 days to prevent leaving the target state, but that the vegetation in the different subsection will be cut in 7 days since the growth rate is much slower due to the lack of rain. Similarly, the vegetation management plans can be created for longer periods of time, based on the types of vegetation in the different subsections. Also, control station can modify the vegetation management plans based on data obtained through the autonomous vehicles, or changes in the weather.

A given device that will be deployed to make the modification is determined (508). The given device can be determined on a number for factors. In some implementations, the given device can be determined based on which devices are located in an area accessible to the area where the modification required to achieve the target state will be made. For example, if two available devices are capable of making the modification, and one of the devices is closer to the area where the modification will be made, the closer device can be selected as the given device that will make the modification.

The given device can also be determined based on how efficiently or effectively different devices can complete the modification. For example, assume that two devices are capable of completing the modification, but that one of the devices is configured to complete the modification in an hour, while the other device will take several more hours to complete the modification. In this example, the device configured to complete the modification more quickly can be selected as the given device that will make the modification.

In some implementations, the given device can be determined based on an amount of power (e.g., battery power) required for the device to complete the modification. For example, assume that one device will use 3 times as much power to complete the modification than another available device. In this example, the device that uses less power can be selected as the given device to preserve power extend battery life of the other device.

The given device is deployed within the geographic area with instructions that cause the given device to make the modification (510). In some implementations, deploying the given device includes causing the given device to navigate within the geographic area. For example, the given device can be a self-driving device that can travel through the geographic area using a set of instructions provided by the control station.

The control station can generate the set of instructions, for example, based on terrain data about the geographic area. The terrain data can be obtained, for example, from scans of the geographic area obtained using one or more sensors, GIS data obtained from a database, or other sources. The control station can analyze the terrain data to identify any obstacles that will interfere with navigation of the self-driving device through the geographic area. For example, the terrain data may specify locations of downed trees, rivers that are impassable due to heavy rains, washed out areas of earth, sinkholes, soft soil, or other obstacles that would prevent, or at least hinder, the navigation of the self-driving device through the geographic area.

Using the terrain data, the control station can generate a navigation path that reduces, or eliminates, the interference of the one or more obstacles with the navigation of the self-driving vehicle within the geographic area. For example, taking the navigation capabilities of the self-driving device, the control station can determine a route that the self-driving device will be able to traverse, and potentially is a shortest route so that battery life of a battery powered device is conserved.

To illustrate, assume, that the self-driving device as the capability to cut through and move downed trees, but that the self-driving device is not buoyant, and can only traverse 3 feet of water. In this illustration, the control station would generate the navigation path to avoid crossing a river that is currently 6 feet deep, even if following the navigation path required the self-driving device to cut through a recently downed tree since the self-driving vehicle can cut and clear the tree, if needed. Once the navigation path is created, the control station can cause the self-driving vehicle to navigate within the geographic area according to the navigation path, for example, by formatting the navigation path in a form executable by the self-driving device (e.g., using an API) and transmitting, or otherwise loading, the instructions into the self-driving device.

In some implementations, the navigation path can be stored and used in the future to again navigate the self-driving device within the geographic area to reduce the need to again process the terrain data and/or generate the navigation path. For example, after causing the self-driving device to navigate according to the navigation path, the control station may again determine that the self-driving device should again navigate along the previously generated navigation path, and simply retrieve the navigation path from a storage location, and instruct the self-driving device in the same manner as before.

However, in some cases, there could now be different obstacles along the navigation path that may require the control station to change how the self-driving device navigates within the geographic area. For example, assume that the control station retrieves the navigation path from the storage location, and also obtains an updated terrain report. In this example, the control station can analyze the navigation path and the updated terrain report to determine whether a new obstacle specified in the updated terrain report is in the previously generated navigation path. If the previously generated navigation path does pass through a location of an obstacle in the updated terrain report, the control station can again use the previously generated navigation path. However, if the control station determines that a new obstacle is located on the previously generated navigation path, the control station can determine that the obstacle impedes navigation of the self-driving device along the navigation path (512), which may require the control station to generate an updated navigation path that differs from the previously generated navigation path.

To illustrate, assume that the control station checks the locations of new obstacles in the updated terrain report, and determines that a new obstacle is along the previously generated navigation path. In this illustration, the control station can then evaluate the characteristics of the obstacle, and whether the self-driving device is configured to overcome (e.g., clear or navigate through) the new obstacle. When the control station determines that the self-driving device is configured to overcome the obstacle (e.g., clearing a downed tree or traversing 2 feet of standing water), the control station can again use the previously generated navigation path. When the control station determines that the self-driving device is not configured to overcome the obstacle, the control station can generate an updated navigation path that reduces the interference of the obstacle with the navigation of the self-driving device (514), and cause the self-driving device to navigate the geographic area according to the updated navigation path (516), in a manner similar to that discussed above.

Operations 512-516 are described with respect to re-deploying the self-driving device, but the operations 512-516 could be performed during navigation of the self-driving device along a generated navigation path. For example, as discussed above with respect to FIG. 3F, when the self-driving device encounters an unexpected or unknown obstacle, the analysis of whether the obstacle impedes navigation of the device along the navigation path can be performed, either by the device itself or the control station. In response to determining that the obstacle impedes navigation of the device over the navigation path (512), an updated navigation path can be generated (514), and the device can be rerouted according to the new navigation path (516).

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random-access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
deploying at least one drone that includes a remote sensing device;
collecting, by the remote sensing device of the at least one drone, a scan of a geographic area;
determining, based on the scan of the geographic area, a modification to the geographic area required to achieve a target state of the geographic area;
determining, based on the collected scan, a given device that will be deployed to make the modification required to achieve the target state of the geographic area; and
deploying the given device in the geographic area with instructions to make the modification required to achieve the target state of the geographic area, wherein deploying the device comprises causing the given device to navigate within the geographic area.

2. The method of claim 1, wherein:
the remote sensing device comprises a Light Detection and Ranging (LIDAR) device; and
collecting a scan of the geographic area comprises generating a LIDAR mapping of a candidate solar field or wind power field.

3. The method of claim 1, wherein:
determining a modification to the geographic area required to achieve a target state of the geographic area comprises determining that vegetation in the geographic area is required to be cut to achieve a height of the vegetation that is below a specified height; and
deploying the given device in the geographic area comprises causing a self-driving device to perform operations comprising:
navigating within the geographic area; and
cutting the vegetation to a height that is less than the specified height.

4. The method of claim 3, further comprising:
training a machine learning model to predict vegetation growth using a set of historical data, including at least one of vegetation growth history for the geographic area, vegetation management activity, or weather data; and
generating a proposed vegetation management plan based on a predicted vegetation growth output by the machine learning model, wherein the proposed vegetation management plan specifies different vegetation cutting schedules for different subsections of the geographic area based on differences in predicted vegetation growth in the different subsections, wherein:
deploying the given device in the geographic area comprises deploying the given device to the different subsections of the geographic area according to the proposed vegetation management plan.

5. The method of claim 3, further comprising:
obtaining, from data collected using one or more sensors, a terrain report specifying one or more obstacles that will interfere with the navigation of the self-driving device within the geographic area;
generating, based on the terrain report, a navigation path that reduces the interference of the one or more obstacles with the navigation of the self-driving device within the geographic area; and
causing the self-driving device to navigate within the geographic area according to the navigation path.

6. The method of claim 5, further comprising:
retrieving the navigation path from a storage location after causing the self-driving device to navigate the geographic area;
determining, based on an updated terrain report, that a different obstacle will currently interfere with the navigation of the self-driving device within the geographic area;
generating, based on the updated terrain report, an updated navigation path that differs from the navigation path; and
causing the self-driving device to navigate the geographic area according to the updated navigation path.

7. The method of claim 3, further comprising:
analyzing the collected scan;
selecting, based on the analyzing of the collected scan, installation locations for one or more of solar field components;
generating instructions that, upon execution, cause one or more autonomous vehicles to transport the one or more solar field components to the selected installation locations for the one or more solar field components; and
causing the one or more autonomous vehicles to transport the one or more solar field components to the selection installation locations for the one or more solar field components.

8. The method of claim 7, wherein selecting installation locations for one or more solar field components comprises selecting one or more of (i) installation locations for posts configured to support solar panels, (ii) inverters, (iii) transformers, (iv) service roads, or (v) a control station.

9. The method of claim 5, further comprising:
detecting, by the self-driving device while navigating within the geographic area, an actionable condition;
reporting, by the self-driving device, the actionable condition to a system controller configured to interact with the self-driving device and one or more other devices; and
causing, by the system controller, the one or more other devices to perform operations that resolve the actionable condition.

10. The method of claim 9, wherein:
detecting the actionable condition comprises determining that vegetation is detected on a post of a solar panel;
causing the one or more other devices to perform operations that resolve the actionable condition comprises causing a vegetation mitigation device to navigate to a location of the post of the solar panel and remove or spray the vegetation.

11. The method of claim 9, wherein:
detecting the actionable condition comprises detecting a characteristic of an object that is not accurately represented in a database storing characteristics of objects located in the geographic area; and
causing the one or more other devices to perform operations that resolve the actional condition comprises updating the database storing characteristics of the objects located in the geographic area to reflect the detected characteristic of the object.

12. The method of claim 9, wherein:
detecting the actionable condition comprises detecting one or more of (i) an out of tolerance temperature reading on a solar panel, (ii) burn marks, (iii) electrical arcing, (iv) a crack in a solar panel, or (v) a ground fault that has not caused a solar panel failure condition; and
causing the one or more other devices to perform operations that resolve the actional condition comprises causing the one or more other devices to perform one or more of (i) generating a visible or audible alarm, (ii) navigate a vehicle to a location of the actionable condition, or (iii) disabling the solar panel.

13. The method of claim 1, further comprising:
monitoring a location of the given device within the geographic area;
remotely adjusting, using one or more optical or electrical control signals, orientations of one or more objects within the geographic area to prevent navigation of the given device from being impeded as the given device approaches locations of the one or more objects.

14. The method of claim 13, wherein adjusting orientations of one or more objects comprises adjusting a tilt angle of a solar panel to an angle that enables the given device to navigate under the solar panel.

15. A system comprising:
one or more memory devices;
at least one computing device configured to interact with the one or more memory devices and execute instructions that cause the at least one computing device to perform operations comprising:
deploying at least one drone that includes a remote sensing device;
collecting, by the remote sensing device of the at least one drone, a scan of a geographic area;
determining, based on the scan of the geographic area, a modification to the geographic area required to achieve a target state of the geographic area;
determining, based on the collected scan, a given device that will be deployed to make the modification required to achieve the target state of the geographic area; and
deploying the given device in the geographic area with instructions to make the modification required to achieve the target state of the geographic area, wherein deploying the device comprises causing the given device to navigate within the geographic area.

16. (canceled)

17. The system of claim 15, wherein:
the remote sensing device comprises a Light Detection and Ranging (LIDAR) device; and
collecting a scan of the geographic area comprises generating a LIDAR mapping of a candidate solar field or wind power field.

18. The system of claim 15, wherein:
determining a modification to the geographic area required to achieve a target state of the geographic area comprises determining that vegetation in the geographic area is required to be cut to achieve a height of the vegetation that is below a specified height; and
deploying the given device in the geographic area comprises causing a self-driving device to perform operations comprising:
navigating within the geographic area; and
cutting the vegetation to a height that is less than the specified height.

19. The system of claim 18, wherein the operations comprise:
training a machine learning model to predict vegetation growth using a set of historical data, including at least one of vegetation growth history for the geographic area, vegetation management activity, or weather data; and
generating a proposed vegetation management plan based on a predicted vegetation growth output by the machine learning model, wherein the proposed vegetation management plan specifies different vegetation cutting schedules for different subsections of the geographic area based on differences in predicted vegetation growth in the different subsections, wherein:
deploying the given device in the geographic area comprises deploying the given device to the different subsections of the geographic area according to the proposed vegetation management plan.

20. The system of claim 18, wherein the operations comprise:
obtaining, from data collected using one or more sensors, a terrain report specifying one or more obstacles that will interfere with the navigation of the self-driving device within the geographic area;
generating, based on the terrain report, a navigation path that reduces the interference of the one or more obstacles with the navigation of the self-driving device within the geographic area; and
causing the self-driving device to navigate within the geographic area according to the navigation path.

21. The system of claim 20, wherein the operations comprise:
retrieving the navigation path from a storage location after causing the self-driving device to navigate the geographic area;
determining, based on an updated terrain report, that a different obstacle will currently interfere with the navigation of the self-driving device within the geographic area;
generating, based on the updated terrain report, an updated navigation path that differs from the navigation path; and
causing the self-driving device to navigate the geographic area according to the updated navigation path.

22. The system of claim 18, wherein the operations comprise:
analyzing the collected scan;
selecting, based on the analyzing of the collected scan, installation locations for one or more of solar field components;
generating instructions that, upon execution, cause one or more autonomous vehicles to transport the one or more solar field components to the selected installation locations for the one or more solar field components; and
causing the one or more autonomous vehicles to transport the one or more solar field components to the selection installation locations for the one or more solar field components.

23. The system of claim 22, wherein selecting installation locations for one or more solar field components comprises selecting one or more of (i) installation locations for posts configured to support solar panels, (ii) inverters, (iii) transformers, (iv) service roads, or (v) a control station.

24. The system of claim 20, wherein the operations comprise:
detecting, by the self-driving device while navigating within the geographic area, an actionable condition;
reporting, by the self-driving device, the actionable condition to a system controller configured to interact with the self-driving device and one or more other devices; and
causing, by the system controller, the one or more other devices to perform operations that resolve the actionable condition.

25. The system of claim 24, wherein:
detecting the actionable condition comprises determining that vegetation is detected on a post of a solar panel;
causing the one or more other devices to perform operations that resolve the actionable condition comprises causing a vegetation mitigation device to navigate to a location of the post of the solar panel and remove or spray the vegetation.

26. The system of claim 24, wherein:
detecting the actionable condition comprises detecting a characteristic of an object that is not accurately represented in a database storing characteristics of objects located in the geographic area; and
causing the one or more other devices to perform operations that resolve the actional condition comprises updating the database storing characteristics of the objects located in the geographic area to reflect the detected characteristic of the object.

27. The system of claim 26, wherein:
detecting the actionable condition comprises detecting one or more of (i) an out of tolerance temperature reading on a solar panel, (ii) burn marks, (iii) electrical arcing, (iv) a crack in a solar panel, or (v) a ground fault that has not caused a solar panel failure condition; and
causing the one or more other devices to perform operations that resolve the actional condition comprises causing the one or more other devices to perform one or more of (i) generating a visible or audible alarm, (ii) navigate a vehicle to a location of the actionable condition, or (iii) disabling the solar panel.

28. The system of claim 15, wherein the operations comprise:
monitoring a location of the given device within the geographic area;
remotely adjusting, using one or more optical or electrical control signals, orientations of one or more objects within the geographic area to prevent navigation of the given device from being impeded as the given device approaches locations of the one or more objects.

29. The system of claim 28, wherein adjusting orientations of one or more objects comprises adjusting a tilt angle of a solar panel to an angle that enables the given device to navigate under the solar panel.

30. A non-transitory computer readable medium storing instructions that, upon execution by at least one computing device, cause the at least one computing device to perform operations comprising:
deploying at least one drone that includes a remote sensing device;
collecting, by the remote sensing device of the at least one drone, a scan of a geographic area;
determining, based on the scan of the geographic area, a modification to the geographic area required to achieve a target state of the geographic area;
determining, based on the collected scan, a given device that will be deployed to make the modification required to achieve the target state of the geographic area; and
deploying the given device in the geographic area with instructions to make the modification required to achieve the target state of the geographic area, wherein deploying the device comprises causing the given device to navigate within the geographic area.

31. The non-transitory computer readable medium of claim 30, wherein:
the remote sensing device comprises a Light Detection and Ranging (LIDAR) device; and
collecting a scan of the geographic area comprises generating a LIDAR mapping of a candidate solar field or wind power field.

32. The non-transitory computer readable medium of claim 30, wherein:
determining a modification to the geographic area required to achieve a target state of the geographic area comprises determining that vegetation in the geographic area is required to be cut to achieve a height of the vegetation that is below a specified height; and
deploying the given device in the geographic area comprises causing a self-driving device to perform operations comprising:
navigating within the geographic area; and
cutting the vegetation to a height that is less than the specified height.

33. The non-transitory computer readable medium of claim 32, wherein the operations comprise:
training a machine learning model to predict vegetation growth using a set of historical data, including at least one of vegetation growth history for the geographic area, vegetation management activity, or weather data; and
generating a proposed vegetation management plan based on a predicted vegetation growth output by the machine learning model, wherein the proposed vegetation management plan specifies different vegetation cutting schedules for different subsections of the geographic area based on differences in predicted vegetation growth in the different subsections, wherein:
deploying the given device in the geographic area comprises deploying the given device to the different subsections of the geographic area according to the proposed vegetation management plan.

34. The non-transitory computer readable medium of claim 32, wherein the operations comprise:
obtaining, from data collected using one or more sensors, a terrain report specifying one or more obstacles that will interfere with the navigation of the self-driving device within the geographic area;
generating, based on the terrain report, a navigation path that reduces the interference of the one or more obstacles with the navigation of the self-driving device within the geographic area; and
causing the self-driving device to navigate within the geographic area according to the navigation path.

35. The non-transitory computer readable medium of claim 34, wherein the operations comprise:
retrieving the navigation path from a storage location after causing the self-driving device to navigate the geographic area;
determining, based on an updated terrain report, that a different obstacle will currently interfere with the navigation of the self-driving device within the geographic area;
generating, based on the updated terrain report, an updated navigation path that differs from the navigation path; and
causing the self-driving device to navigate the geographic area according to the updated navigation path.

36. The non-transitory computer readable medium of claim 32, wherein the operations comprise:
analyzing the collected scan;
selecting, based on the analyzing of the collected scan, installation locations for one or more of solar field components;
generating instructions that, upon execution, cause one or more autonomous vehicles to transport the one or more solar field components to the selected installation locations for the one or more solar field components; and
causing the one or more autonomous vehicles to transport the one or more solar field components to the selection installation locations for the one or more solar field components.

37. The non-transitory computer readable medium of claim 36, wherein selecting installation locations for one or more solar field components comprises selecting one or more of (i) installation locations for posts configured to support solar panels, (ii) inverters, (iii) transformers, (iv) service roads, or (v) a control station.

38. The non-transitory computer readable medium of claim 34, wherein the operations comprise:
detecting, by the self-driving device while navigating within the geographic area, an actionable condition;
reporting, by the self-driving device, the actionable condition to a system controller configured to interact with the self-driving device and one or more other devices; and
causing, by the system controller, the one or more other devices to perform operations that resolve the actionable condition.

39. The non-transitory computer readable medium of claim 38, wherein:
detecting the actionable condition comprises determining that vegetation is detected on a post of a solar panel;
causing the one or more other devices to perform operations that resolve the actionable condition comprises causing a vegetation mitigation device to navigate to a location of the post of the solar panel and remove or spray the vegetation.

40. The non-transitory computer readable medium of claim 38, wherein:
detecting the actionable condition comprises detecting a characteristic of an object that is not accurately represented in a database storing characteristics of objects located in the geographic area; and
causing the one or more other devices to perform operations that resolve the actional condition comprises updating the database storing characteristics of the objects located in the geographic area to reflect the detected characteristic of the object.

41. The non-transitory computer readable medium of claim 40, wherein:
detecting the actionable condition comprises detecting one or more of (i) an out of tolerance temperature reading on a solar panel, (ii) burn marks, (iii) electrical arcing, (iv) a crack in a solar panel, or (v) a ground fault that has not caused a solar panel failure condition; and
causing the one or more other devices to perform operations that resolve the actional condition comprises causing the one or more other devices to perform one or more of (i) generating a visible or audible alarm, (ii) navigate a vehicle to a location of the actionable condition, or (iii) disabling the solar panel.

42. The non-transitory computer readable medium of claim 30, wherein the operations comprise:
monitoring a location of the given device within the geographic area;
remotely adjusting, using one or more optical or electrical control signals, orientations of one or more objects within the geographic area to prevent navigation of the given device from being impeded as the given device approaches locations of the one or more objects.

43. The non-transitory computer readable medium of claim 42, wherein adjusting orientations of one or more objects comprises adjusting a tilt angle of a solar panel to an angle that enables the given device to navigate under the solar panel.
